(19) United States
(12) Patent Application Publication
(10) Pub. No.: US 2020/0026731 A1
(43) Pub. Date: Jan. 23, 2020

(54) Systems and Methods for Archiving and Accessing of Image Content

(71) Applicant: Vidit, LLC, Layton, UT (US)

(72) Inventors: Rene Rodriguez, Layton, UT (US); George Michael Theodore, Greensboro, NC (US); Rodrigo Moya, Layton, UT (US)

(21) Appl. No.: 16/506,791

(22) Filed: Jul. 9, 2019

Related U.S. Application Data
(60) Provisional application No. 62/699,530, filed on Jul. 17, 2018.

(51) Int. Cl. G06F 16/906; G06F 16/904; G06F 16/9038; G06F 16/908; G06F 16/909; G06F 16/9035

(52) U.S. Cl. CPC G06F 16/906; G06F 16/904; G06F 16/9035; G06F 16/908; G06F 16/909; G06F 16/9038

(57) ABSTRACT

A system for archival and access of image content is provided. The system includes a database configured to store one or more interactive images collected from a social media platform. The system further includes an archival subsystem coupled to the database. The archival subsystem is configured to receive the one or more interactive images from the database. The archival subsystem is also configured to archive the one or more interactive images based on a plurality of parameters, where the plurality of parameters includes a location and a contributor. The system further includes an access subsystem coupled to the archival subsystem. The access subsystem is configured to provide an access of one or more archived interactive images based one or more features, where the one or more feature includes proximity, permission or popularity.

### CROSS-RELATED APPLICATIONS

This application claims priority to U.S. Provisional Patent Application No. 62/699,530 which was filed Jul. 17, 2018.

### BACKGROUND

A social media platform is a web-based technology which enables the development, deployment and management of a plurality of social media solutions and a plurality of services. Using such services, the social media platform may engage individuals, communities, and organizations to share, co-create, discuss, and modify one or more user-generated content such as multimedia content.

### SUMMARY

In accordance with an embodiment of the present invention, a system for archiving and access of image content is provided. The system includes a database configured to store one or more interactive images collected from a social media platform or from image capture. In one embodiment, the one or more interactive images may include one or more images embedded with one or more attributes such as a video, a location, a three-dimensional content or a virtual reality video. The system further includes an archival subsystem coupled to the database. The archival subsystem is configured to receive the one or more interactive images from the database. The archival subsystem is also configured to archive the one or more interactive images based on a plurality of parameters, wherein the plurality of parameters includes a location and a contributor. The system further includes an access subsystem coupled to the archival subsystem. The access subsystem is configured to provide an access of one or more archived interactive images based one or more features, where the one or more features include proximity, permission or popularity.

In accordance with another embodiment of the present invention, a method for archiving and accessing of image content is provided. The method includes storing one or more interactive images in a database. In one embodiment, storing one or more interactive images in a database may include storing one or more images embedded with one or more attributes such as a video, a location, a three-dimensional content or a virtual reality video. The method also includes receiving the one or more interactive images from the database. The method further includes archiving and curating the one or more interactive images based on a plurality of parameters, where the plurality of parameters includes a location and a contributor. The method further includes providing an access of one or more archived interactive images based one or more features, where the one or more feature includes proximity, permission or popularity.

To further clarify the advantages and features of the present invention, a more particular description of the invention will follow by reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram of a system for archival and access of image content in accordance with an embodiment of the present disclosure;

FIG. 2 is a block diagram of an exemplary embodiment the system for archival and access of image content of FIG. 1 in accordance with an embodiment of the present disclosure; and

FIG. 3 is a flow chart representing the steps involved in a method for archival and access of image content of FIG. 1 in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those skilled in the art having the benefit of the description herein.

### DETAILED DESCRIPTION OF THE INVENTION

For the purpose of promoting an understanding of the principles of the invention, reference will now be made to the embodiment illustrated in the figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

Embodiments of the present invention will be described below in detail with reference to the accompanying figures.

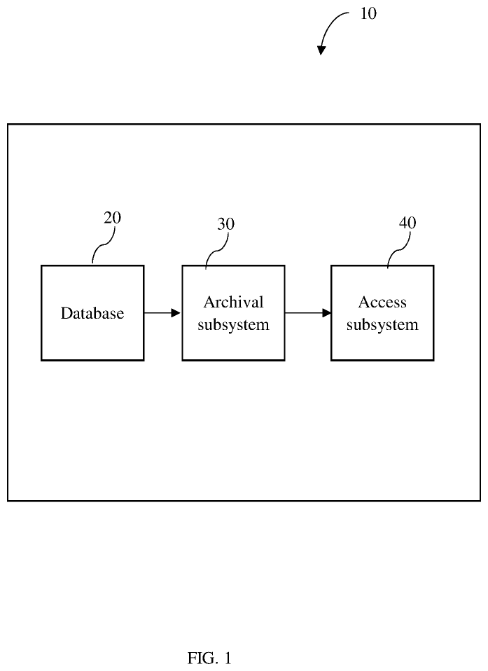

FIG. 1 is a block diagram of a system 10 for archival and access of image content in accordance with an embodiment of the present invention. The system 10 includes a database 20 configured to store one or more interactive images. In one embodiment, the one or more interactive images may include one or more images embedded with one or more attributes such as a video, a location, a three-dimensional content or a virtual reality video. The system 10 also includes an archival subsystem 30 coupled to the database 20. The archival subsystem 30 is configured to receive the one or more interactive images from the database 20. In some embodiments, the archival subsystem 30 may be configured to map the one or more interactive images that are intended for archival purposes to their locations in the database on a recording media. In a specific embodiment, the archival subsystem 30 may be configured to select a plurality of images from the one or more interactive images and categorizing a plurality of selected images for archival process.

As used herein, the terms “creator,” “user” and “contributor” are interchangeable.

Furthermore, the archival subsystem 30 is further configured to archive the one or more interactive images based on a plurality of parameters, where the plurality of parameters includes a location, and a contributor, content and date. As used herein the term “archival” is defined as a process where an information considered valuable is recorded on a media suitable for long-term storage. In a specific embodiment, the archival subsystem 30 may archive the interactive images based on the location of a user when the image was captured. In such an embodiment, the archival subsystem 30 may archive the one or more image in an ascending order of distance from a location. In one embodiment, the archival subsystem 30 may archive the interactive images based on the contributor of the interactive image. As used herein, the contributor is a person who has a profile on the system and shares with others on a permissioned basis a plurality of interactive images. In a specific embodiment, one or more archival interactive images may include a tagged image file format (TIFF).

Moreover, the system 10 further includes an access subsystem 40 coupled to the archival subsystem. The access subsystem 40 is configured to provide an access of one or more archived interactive images based one or more features, where the one or more feature includes proximity, permission or popularity. In one embodiment, the access subsystem 40 may provide access of the one or more archived interactive images based on proximity of the user near to a place embedded in the one or more archived interactive images.

In another embodiment, the access subsystem 40 may be configured to provide access to archived interactive images based on a viewing permission embedded into the one or more archived interactive images. In such an embodiment, the viewing permission may include a private permission representative of a permission to one or more specific people to view the one or more archived interactive images and a public permission representative of the permission to any person to view the one or more archived interactive images.

In another embodiment, permission to access images are applied to all images in a portion of the database assigned to a particular user and not embedded with the image. Such embedding usually occurs on the smartphone as the image is captured. Permissions may also be applied as settings on all images or select iMaps stored on a server under the user's ID.

In yet another embodiment, the access subsystem 40 may be configured to provide access of the one or more archived interactive images based on popularity of the one or more archived interactive images on the social media platform. In such embodiment, the more popular interactive image may be accessed by any user on the social media platform than the less popular interactive image.

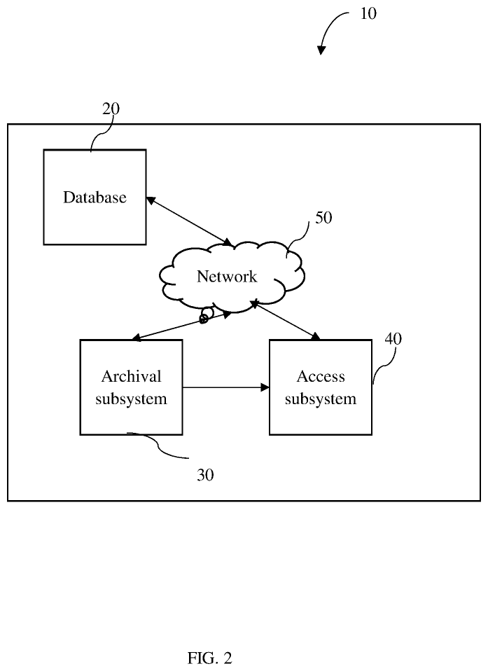

FIG. 2 is a block diagram of an exemplary embodiment of a system 10 for archival and access of the image content of FIG. 1 in accordance with an embodiment of the present invention. On a social media platform, a plurality of users shares one or more media contents for interaction with each other. Such one or more media contents are used for gathering information useful for the plurality of users in their real-life environment. The information which is no longer actively used is moved on a storage device for long term retention which is known as an archiving process. The images may also be sorted and stored by creator, location or turning in a processed referred to herein as “curating.” On the social media platform, such inactive data such as one or more interactive images are also moved to the database 20. The one or more interactive images may include one or more images embedded with one or more attributes such as a video, a location, a three-dimensional content or a virtual reality video.

The system 10 for archival and access of image content includes the archival subsystem 30 which is operatively coupled to the database 20. The archival subsystem receives the one or more interactive images from the database 20. In one embodiment, the archival subsystem 30 may be communicatively coupled to the database 20 using a communication network 50. In some embodiments, the communication network 50 may include wired communication network such as LAN. In another embodiment, the communication network 50 may include a wireless communication network such as 2G, 3G, 4G, LTE, HSDPA, Wi-Fi, Bluetooth, ZigBee, Low Power WAN or the like.

The archival subsystem 30 may then map the one or more interactive images that are intended for archival purposes to their locations in the database 20 on the storage device. A plurality of images which are to be archived may be selected from the plurality of interactive images and curated. The archival subsystem 30 then archives the one or more interactive images based on a plurality of parameters, where the plurality of parameters includes a location and a contributor. For example, when a user reaches to a place whose location may be embedded into the one or more interactive image, the system 10 archives one or more images related to such location in a serial manner from the storage device. The one more interactive images shared the plurality of users may be arranged based on name of the contributor of such images. For example, in a day a user x, a use y and a user z may share approximately 10 images which is to be archived, the system archives the one or more images based on the name of the users such as an archival of 5 images shared by user x in a periodic pattern, then the archival of 3 images shared by user y in a periodic pattern and then the archival of 2 images shared by user z in a periodic pattern on a profile of the user on the social media platform.

The system 10 also includes the access subsystem 40 operatively coupled to the archival subsystem 30. The access subsystem 40 provides an access of one or more archived and curated interactive images based one or more features, where the one or more feature includes proximity, permission or popularity. In one embodiment, the access subsystem 40 may provide access of the one or more archived interactive images based on proximity of the user near to a place embedded in the one or more archived interactive images. For example, if a user x which is currently near a location embedded in the one or more archived interactive images, then the access subsystem 40 provides search results with location stamps similar or near to the location of user x. Search results may also be displayed with the image being the closest location stamp presented first. Additionally, if the curated images have a permission requirement that is met by user x's profile, then those images will also appear in search results.

In another embodiment, the access subsystem 40 may provide access of the one or more archived interactive images based on a viewing permission embedded into the one or more archived interactive images. For example, a private permission representative of a permission is provided to one or more specific users to view the one or more archived interactive images or a public permission representative of the permission is provided to any person to view the one or more archived interactive images.

In yet another embodiment, the access subsystem 40 may provide access of the one or more archived interactive images based on popularity of the one or more archived interactive images on the social media platform. For example, the more frequently searched interactive images which are more persistently or periodically re-shared or for which searches are requested more frequently will be presented in the search results first.

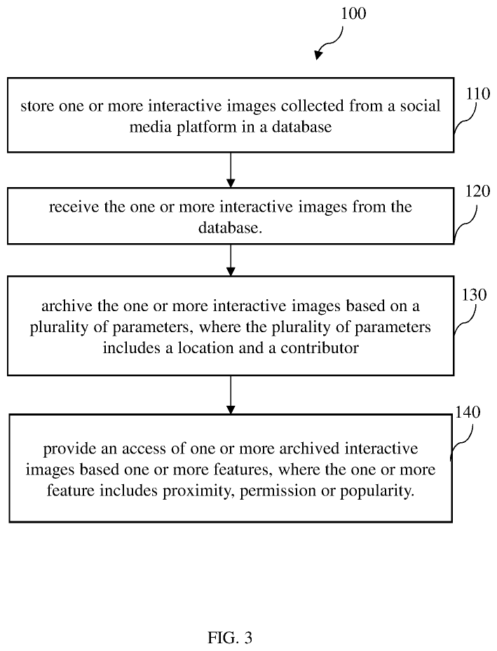

FIG. 3 is a flow chart representing the steps involved in a method 100 for archiving, curating and accessing the image content of FIG. 1 in accordance with an embodiment of the present disclosure. The method 100 includes storing one or more interactive images collected from a social media platform in a database in step 110. In one embodiment, storing one or more interactive images collected from a social media platform in a database may include storing one or more images embedded with one or more attributes such as a video, a location, a three-dimensional content or a virtual reality video. The method 100 also includes receiving the one or more interactive images from the database in step 120. In some embodiments, the method 100 may include mapping the one or more interactive images that are intended for archival purposes to their locations in the database on a recording media. In a specific embodiment, the method 100 may further include selecting a plurality of images from the one or more interactive images and categorizing a plurality of selected images for archival process.

Furthermore, the method 100 includes archiving and curating the one or more interactive images based on a plurality of parameters, where the plurality of parameters includes a location and a contributor in step 130. In a specific embodiment, archiving the one or more interactive images based on a plurality of parameters may include archiving the one or more interactive images based on the location of a user. In such embodiment, archiving the one or more interactive images may include archiving the one or more image in an ascending order of a distance from the location. In one embodiment, archiving the one or more interactive images based on a plurality of parameters may include archiving the one or more interactive images based on the contributor of an interactive image.

The method 100 further includes providing an access of one or more archived interactive images based one or more features, where the one or more feature includes proximity, permission or popularity in step 140. In one embodiment, providing an access of the one or more archived interactive images based the one or more features may include providing access of the one or more archived interactive images based on proximity of the user near to a place embedded in the one or more archived interactive images. In another embodiment, providing an access of the one or more archived interactive images based the one or more features may include providing access of the one or more archived interactive images based on a viewing permission embedded into the one or more archived interactive images.

In such embodiment, providing access of the one or more archived interactive images based on a viewing permission embedded into the one or more archived interactive images may include providing access of the one or more archived interactive images based on a private permission representative of a permission to one or more specific people to view the one or more archived interactive images and a public permission representative of the permission to any person to view the one or more archived interactive images.

In yet another embodiment, providing an access of the one or more archived interactive images based the one or more features may include providing the access of the one or more archived interactive images based on popularity of the one or more archived interactive images on the social media platform.

Various embodiments of the system and the method for archival and access of image content described above enables a fast, efficient and real-time archival of interactive image and their access as the interactive image is archived based on location and the contributor of the interactive image. In addition, searching of the contents of the digital versions using such archival method may made searching and their access powerful.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for archiving and searching image content comprising;
a database configured to store images, video and interactive media sent from a smartphone through a computer program on the smartphone which captures media and attaches information such as location, user identification, time and permissions on viewing; and
a search engine designed to search by image content for recognizing an image and finding other captures of that image or images with similar content.

2. A system as recited in claim 1, wherein the stored images are stored on a database with an association to a profile of a user such that images submitted by that user are kept with the profile of the user who created and submitted the image.

3. A system as recited in claim 2, wherein the search engine which has been requested to perform a search of a requested image assesses factors such as co-locations and time to verify that a retrieved image is similar to the requested image.

4. A system as recited in claim 3, wherein the search engine analyses the location stamp to verify that an image discovered in a search request for an image of an object is of the same object identified in other images.

5. A method for archiving and accessing image content comprising:
storing interactive images collected from a social media platform in a database;
archiving and curating the interactive images based on parameters including the location where the interactive image was created; and
identity of the creator, the frequency with which the image has been accessed, the proximity of the location of the creation of the interactive image to a user's current location, and whether the user has permission to view the interactive image.

6. A method as recited in claim 5, wherein the interactive images are embedded with an attribute which is a video.

7. A method as recited in claim 5, wherein the interactive images are embedded with an attribute which is a location.

8. A method as recited in claim 5, wherein the interactive images are 3D.

9. A method as recited in claim 5, wherein the interactive images are virtual reality.
